(19) United States
(12) Patent Application Publication
(10) Pub. No.: US 2008/0165978 A1
(43) Pub. Date: Jul. 10, 2008

(54) Hearing Device Sound Simulation System and Method of Using the System

(75) Inventors: John Cronin, Jericho, VT (US); Tushar Narsana, Naperville, IL (US)

Correspondence Address: MCCARTER & ENGLISH, LLP, FOUR GATEWAY CENTER, 100 MULBERRY STREET, NEWARK, NJ, 07102, US

(73) Assignee: JOHNSON & JOHNSON CONSUMER COMPANIES, INC., Skillman, NJ (US)

(21) Appl. No.: 11/570,458

(22) PCT Filed: Jun. 13, 2005
(86) PCT No.: PCT/US05/20824

§ 371 Date: Oct. 2, 2007

Related U.S. Application Data
(60) Provisional application No. 60/579,368, filed on Jun. 14, 2004.

(51) Int. Cl. H04R 29/00

(52) U.S. Cl. 381/58

(57) ABSTRACT

The present invention relates to hearing aid training systems (100). More particularly, the present invention relates to the simulation of a hearing aid environment (108) prior to a user's (105) purchase of a hearing aid. To create the simulated environment, the user's hearing profile (111) is collected from all prior hearing tests. Prior hearing tests include information on all aspects of the user's hearing, such as frequency and speech intelligibility. The software program (126) of this invention, and the audiologist using the software program (126), analyzes the user's hearing profile and creates a simulation that demonstrates to the user how he or she would hear with a hearing aid. Furthermore, this invention provides a way to make additional adjustments to the hearing aid's DSP data based upon user preferences prior to ordering the individual customized hearing aid.

### CROSS REFERENCE TO RELATED APPLICATION

This application claims the benefit of U.S. Provisional Application No. 60/579,368 filed Jun. 14, 2004, assigned to the assignee of this application and incorporated by reference herein.

### FIELD OF THE INVENTION

The present invention relates to hearing aid training systems. More particularly, the present invention relates to the creation of a simulated environment of what a user with hearing loss will hear after he or she has purchased and fitted a hearing aid. The data to simulate the environment is collected from prior hearing tests conducted on the user.

### BACKGROUND OF THE INVENTION

More than 25 million Americans have hearing loss, including one out of four people older than 65. Hearing loss may come from infections, strokes, head injuries, some medicines, tumors, other medical problems, or even excessive earwax. It can also result from repeated exposure to very loud noise, such as music, power tools, or jet engines. Changes in the way the ear works as a person ages can also affect hearing.

For most people who have a hearing loss, there are ways to correct or compensate for the problem. If an individual has trouble hearing, that individual can visit a doctor or hearing health care professional to find out if he or she has a hearing loss and, if so, to determine a remedy. The U.S. Food and Drug Administration (FDA) and similar governing bodies in other countries have rules to ensure that treatments for hearing loss—medicines, hearing aids, and other medical devices—are tried and tested.

However, most people do not even know that they have a hearing loss. Typical indications that an individual has hearing loss include: (1) shouting when talking to others, (2) needing the TV or radio turned up louder than other people do, (3) often having to ask people to repeat what they say because the individual can't quite hear them, especially in groups or when there is background noise, (4) not being able to hear a noise when not facing the direction it's coming from, (5) seeming to hear better out of one ear than the other, (6) having to strain to hear, (7) hearing a persistent hissing or ringing background noise, and (8) not being able to hear a dripping faucet or the high notes of a violin. If an individual experiences one of more of the above indications, the individual should see his or her doctor or hearing health care professional for further testing for potential hearing loss.

To find out what kind of hearing loss the individual has and whether all the parts of the individual's ear are functioning, the person's doctor may want him or her to take a hearing test. A health care professional that specializes in hearing, such as an audiologist, often gives these tests. Audiologists are usually not medical doctors, but they are trained to give hearing tests and interpret the results. Hearing tests are painless.

If the hearing test shows that the individual has a hearing loss, there may be one or more ways to treat it. Possible treatments include medication, surgery, or a hearing aid. Hearing aids can usually help hearing loss that involves damage to the inner ear. This type of hearing loss is common in older people as part of the aging process. However, younger people can also have hearing loss from infections or repeated exposure to loud noises.

In a well-known method of testing hearing loss in individuals, the threshold of the individual's hearing is typically measured using a calibrated sound-stimulus-producing device and calibrated headphones. The measurement of the threshold of hearing takes place in an isolated sound room, usually a room where there is very little audible ambient noise. The sound-stimulus-producing device and the calibrated headphones used in the testing are known as an audiometer.

A professional audiologist performs a professional hearing test by using the audiometer to generate pure tones at various frequencies between 125 Hz and 12,000 Hz that are representative of a variety of frequency bands. These tones are transmitted through the headphones of the audiometer to the individual being tested. The intensity or volume of the pure tones is varied until the individual can just barely detect the presence of the tone. For each pure tone, the intensity at which the individual can just barely detect the presence of the tone is known as the individual's air conduction threshold of hearing. Although the threshold of hearing is only one element among several that characterizes an individual's hearing loss, it is the predominant measure traditionally used to acoustically fit a hearing compensation device.

The audiometer apparatus uses headphones when testing the individual's hearing. The results of the test will be used to design a hearing aid, which is typically a hearing aid with a digital signal processor (DSP) that uses frequency and amplitude adjustments to create an amplifier and filter that is customized to the patient. However, it is difficult to calibrate the exact adjustment of the hearing-aid device to be worn by the individual based upon the use of headphones in the hearing test. A problem associated with the use of headphones to present tones to the individual is that, due to the unique acoustics of each individual's ear canal, the individual's perception of the sound transmitted by the headphones is different from the individual's perception of sound transmitted by the actual hearing-aid device in the individual's ear canal.

Once the individual's hearing compensation in the hearing test has been determined, the compensation factors are sent to the manufacturer for programming the DSP of the hearing aid. The hearing aid is manufactured, programmed, and then sent to the audiologist. The audiologist physically fits the hearing aid to the individual's ear and makes any necessary electrical adjustments, such as helping the individual set the volume control, and any other adjustments the hearing aid allows. The hearing aid is adjusted in reference to the results of a second test that the audiologist conducts on the individual with the hearing aid in place. However, the results of the hearing retest may require further frequency versus amplitude adjustments that are not possible after the manufacturer defines the settings. This often happens because, due to differences in acoustics, an individual may respond differently in a hearing test conducted with headphones than in the same hearing test conducted with a programmed hearing aid.

To overcome the problems associated with an audiometer apparatus that employs either headphones or a generic device that fits into the ear to test for hearing loss, a prior art fitting system uses a programmable hearing aid worn by the individual as the means of generating the tones used to assess the hearing loss. In addition to having programmable parameters for the signal processing circuits that provide hearing compensation, the hearing aid also has various circuit components that may be trimmed to compensate for variations in electrical characteristics.

However, the prior art assumes that an individual has already purchased, or is very close to purchasing, a programmable hearing aid. In most cases, the first time an individual tries a hearing aid is post-purchase, and the sudden difference in hearing capability may confuse the individual. For example, the individual may find some spoken words more confusing initially with a hearing aid than without a hearing aid. It is estimated that such overwhelmed individuals prematurely return 25% of hearing aids. This high rate of return can lead to significant monetary losses for a hearing aid manufacturer. Therefore, what is needed is a way of reducing this rate of return for hearing aid manufacturers. What is also needed is an intermediate step, between the onset of testing an individual for hearing loss and the fitting of the custom hearing aid, to train and transition the individual as to how he or she will ultimately hear with a hearing aid.

Furthermore, audiological tests and hearing aid fitting devices in the prior art have done little to address the other hearing needs of an individual, such as speech intelligibility (i.e., understanding spoken words and sentences), ambient noise in real-world settings that interferes with hearing conversations, and the impact of an individual's psychological makeup on the hearing improvement process. Not addressing these other hearing needs prior to fitting a hearing aid further increases the chance of overwhelming an individual once he or she has put on a hearing aid. Therefore, what is needed is a way to train and transition the individual as to the potential improvement to all his or her hearing needs prior to the purchase and fitting of a hearing aid.

It is therefore an object of the present invention to demonstrate a way of simulating a hearing aid device, prior to an individual's purchase of a hearing aid device, so that the individual can be acclimated and trained on how he or she will hear with a hearing aid.

It is another object of the present invention to demonstrate a way of simulating a hearing aid device that addresses all the individual's hearing needs, prior to the individual's purchase of a hearing aid device.

It is yet another object of the present invention to illustrate a method of improving customer satisfaction when buying a hearing aid unit and reducing the rate of return on hearing aid units to manufacturers.

### SUMMARY OF THE INVENTION

The present invention relates to hearing aid training systems. More particularly, the present invention relates to the simulation of a hearing aid environment prior to a user's purchase of a hearing aid. To create the simulated environment, the user's hearing profile is collected from all prior hearing tests. Prior hearing tests include information on all aspects of the user's hearing, such as frequency and speech intelligibility. The software program of this invention, and the audiologist using the software program, analyzes the user's hearing profile and creates a simulation that demonstrates to the user how he or she would hear with a hearing aid. For example, if the user has degradation in the high frequency range, i.e., low pass frequencies are easier to hear, the created simulation plays all the words and sentences that the user may interpret differently when wearing the hearing aid. Through this simulation, the user understands how these words and sentences will sound with a hearing aid. Furthermore, this invention provides a way to make additional adjustments to the hearing aid's DSP data based upon user preferences prior to ordering the individual customized hearing aid. This will help reduce the rate of return of hearing aids to manufacturers.

Thus, the present invention provides a method for simulating a hearing aid environment comprising:
generating a hearing loss profile including frequency versus amplitude test data, based on performance of a hearing aid test;
computing digital signal processor (“DSP”) correction factors based on the frequency versus amplitude test data;
identifying at least one word in a test word database having at least one frequency component substantially equal to one (e.g. within the range) of the frequencies corresponding to the DSP factors;
generating a normal version sound output of the word, wherein the normal sound output is the word without application of a DSP correction factor; and
generating a modified version sound output of the word, wherein the modified sound output is the word as modified by the DSP correction factor for the one (e.g. range) of the frequencies.

In a further embodiment, the method comprises playing the sound output at an annunciator (e.g. headphones) coupled to a controller and a DSP.

In a further embodiment, the method includes retrieving the hearing aid test from a remote hearing health database via a network interface.

In a further embodiment, the method includes modifying as least one of the DSP factors based on user characteristics data (e.g., lifestyle and desire for greater initial comprehension).

In a further embodiment, the method includes receiving user feedback data and adjusting the DSP factors based on the feedback data.

Thus, the present invention further provides for a system for simulating a hearing aid environment comprising:
a controller including a digital signal processor (“DSP”) and a memory; and
an annunciator (headphones), a user data input device (e.g., mouse, keyboard, GUI) and a network communications interface coupled to the controller, wherein the memory includes a hearing test applications program and the controller executes the program for causing transmission of data to and reception of data from a remote hearing health database at the network interface, wherein the DSP generates DSP factor word data based on a DSP correction factor stored in the memory and word data representative of a test word, wherein the DPS correction factor is based on frequency versus amplitude test data, wherein the annunciator generates a modified sound output of the word upon receipt of the DSP factor word data, and wherein the annunciator generates a normal sound output of the word upon receipt of the word data, and wherein the test word has at least one frequency component substantially equal to one (e.g. within the range) of the frequencies corresponding to the DSP factors.

In a further embodiment of the system, the controller adjusts the DSP factors in the memory based on feedback data provided at the user data input device.

### BRIEF DESCRIPTION OF THE DRAWINGS

Other objects and advantages of the present invention will be apparent from the following detailed description of the presently preferred embodiments, which description should be considered in conjunction with the accompanying drawings in which like references indicate similar elements and in which:

FIG. 1 is a high-level system diagram of a hearing device sound simulation.

FIG. 2 is a table showing an individual's hearing profile at specific amplitudes for numerous frequencies and the amplification factor needed for adjusting their hearing to a normal level.

FIG. 3 is a table showing words and sentences affected by an individual's hearing profile for specific frequencies at low-pass, band-pass, high-pass and notch hearing types.

FIG. 4 is a high-level system diagram of a computer system that creates an audio simulation and communicates with databases storing information that goes to the simulator.

FIG. 5 is a flow chart showing how a user would interact with a hearing device sound simulation.

### DESCRIPTION OF THE INVENTION

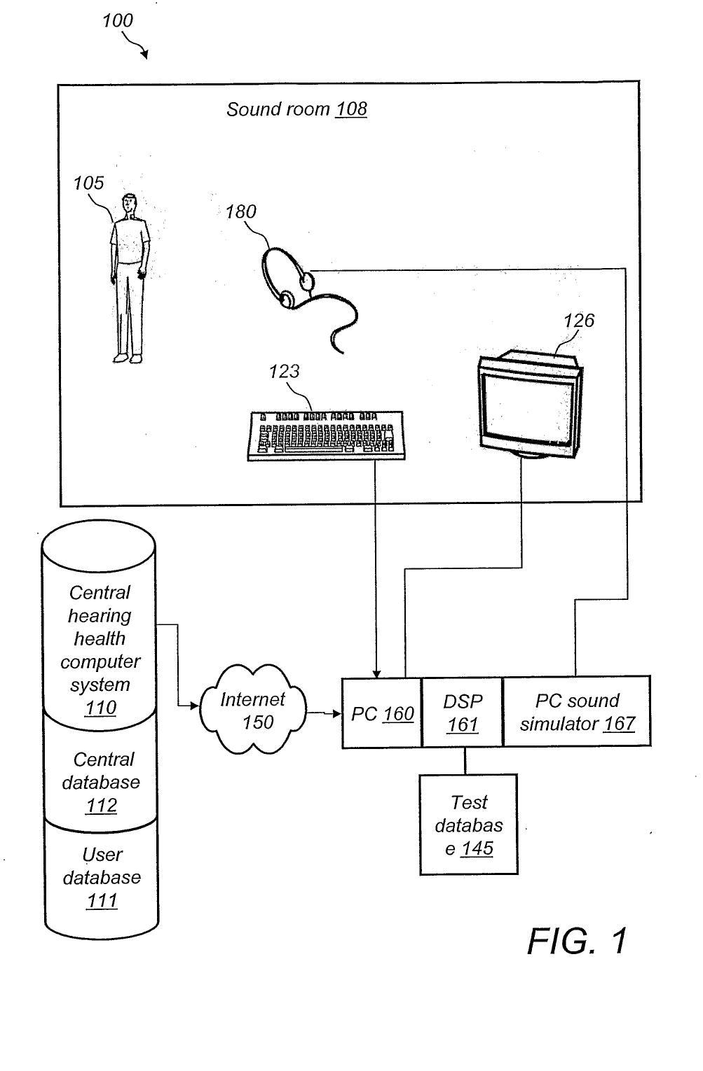

FIG. 1 is a system 100, consisting of a user 105, a sound room 108, a central hearing health computer system 110, a user database 111, a central database 112, a keyboard 123, a monitor 126, a pair of headphones 180, a test database 145, an Internet 150 connection, a personal computer (PC) 160, a PC sound simulator 167, and a digital signal processor (DSP) 161.

User 105 is the patient, who is wearing a pair of conventional headphones 180 in sound room 108. User 105 represents the individuals (mass market) on whom a hearing test is to be administered. This is generally any and all individuals, but more specifically, the more than 10% of the population (e.g., 25 million Americans) that have hearing loss, including one out of four people older than 65. Hearing loss may come from infections, strokes, head injuries, certain medicines, tumors, other medical problems, or an excess of earwax. It can also result from repeated exposure to very loud noise, such as music, power tools, or jet engines. Changes in the way the ear performs as a person ages can also affect hearing.

Sound room 108 is a soundproof room that provides a suitable environment for a hearing test. PC 160 is the central input-output processing unit (that includes keyboard 123, monitor 126, and all PC-related hardware such as disk drives, memory, modems, or connection means, all not shown). Monitor 126 and keyboard 123 are output and input devices, respectively, for PC 160. PC sound simulator 167 simulates the sound for a hearing test. Central hearing health computer system 110 is a remote system that is connected to PC 160 through Internet 150.

Internet 150 is a standard Internet connection, or alternatively is a WAN, LAN, etc. Internet 150 is the communication infrastructure between PC 160 and central hearing health computer system 110. Internet 150 allows central hearing health computer system 110 to remotely administer hearing aid tests, thereby allowing central hearing health computer system 110 the opportunity to reach a large number of individuals.

PC 160 further contains test database 145 to store information such as patient profiles, hearing amplification tables, and patient test results. Test database 145 also stores information such as software programs and information that is downloaded from central hearing health computer system 110.

DSP 161 is a real-time digital signal processor that allows the frequency versus amplitude digital data signal input to it to be filtered or attenuated based upon loading DSP 161 with the hearing test data. DSP 161 then provides a digital-to-analog conversion before sending its output to PC sound simulator 167.

PC sound simulator 167 is a high-quality sound card amplifier that plays the output of DSP 161 on headphones 180.

Central hearing health computer system 110 is a centrally located computer system that is connected to Internet 150, and is capable of performing all normal computer functions, such as reading and writing data to memory (within central hearing health computer system 110), reading and writing data to PC 160, communicating through modem or network connections, and running user test programs. Central hearing health computer system 110 is a central repository of all current audiological programs, audiological data, audiological research, sound “.wav” files, and speech and other sound simulations files. Central hearing health computer system 110 centralizes information such that all connected audiologists around the world can access the current audiological test procedures, new standards, new algorithms for programming devices, such as DSP-based hearing aids.

User database 111 is a memory region of central hearing health computer system 110 that stores user data such as demographics information (age, name, date of birth, etc.), but also includes the user's actual responses to the hearing tests. Central database 112 is another memory region of central hearing health computer system 110, and stores user test programs (not shown).

In operation, an audiologist links to central hearing health computer system 110 through PC 160 and Internet 150 to upload any current information from central database 112 and user database 111, which is then loaded and stored on test database 145. The audiologist runs the hearing test programs on PC 160 with headphones 180 on user 105. The program sends sounds (tones) at various amplitudes directly to PC sound simulator 167 (bypassing DSP 161), which sends the sounds to headphones 180 and, optionally, may send information or questions to monitor 126. The audiologist looks for interaction from user 105, either verbally or via keyboard 123. In addition, user 105 can be tested for speech intelligibility, with the program playing pre-defined sentences instead of tones. In this way, the hearing of user 105 can be tested. If user 105 has previously taken a low-cost screening test, receiving a diagnostic code from that test, the first request of the program would be for user 105 to enter the code using keyboard 123.

Once the hearing test has been run at various frequencies and amplitudes, the audiologist compares the results of the test with the norms for a healthy hearing response. This comparison provides DSP correction factors, which are differences in frequency and amplitude ranges that may need more amplification or attenuation. These differences are automatically calculated and presented to the audiologist for adjustment. The audiologist may, given other information about the lifestyle of user 105, choose to override some of the calculated results. This modified frequency versus amplitude test data is stored on test database 145 and is also transferred from PC 160 to user database 111 on central hearing health computer system 110.

With the DSP correction factors from the previous test loaded into DSP 161, the audiologist then conducts a second hearing test, allowing user 105 to respond to tones and/or speech that approximate sounds corrected by the hearing aid device. The audiologist may further adjust the DSP correction factors and retry this test. The final DSP correction factors are stored on test database 145 and then uploaded to central hearing health computer system 110 through PC 160 and Internet 150 to update the existing information on central database 112 and user database 111.

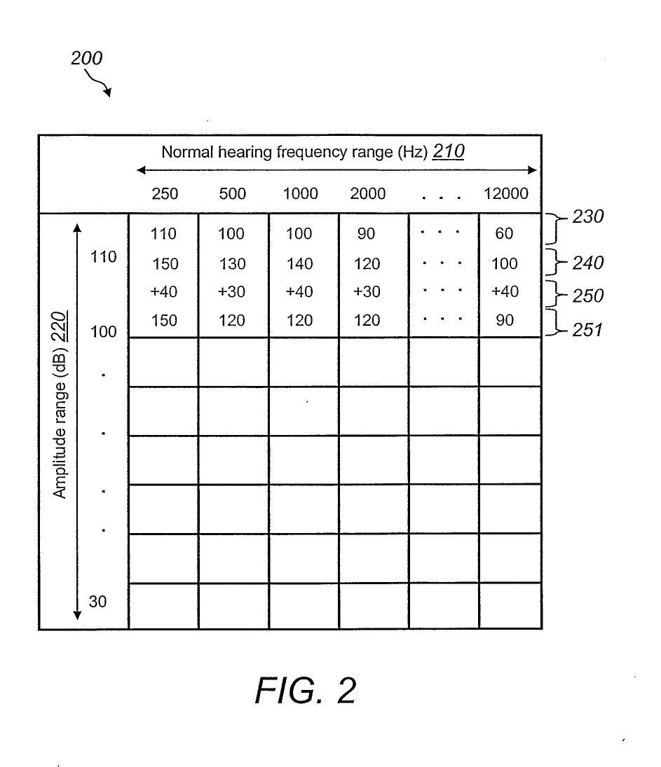

FIG. 2 illustrates a table 200 including a normal hearing frequency range 210, an amplitude range 220, an example of values for individual hearing 230, an example of values for normal hearing 240, an amplification factor 250, and an example of values for perceived hearing 251.

Humans hear at frequencies ranging from 15 to 20,000 hertz (Hz). Normal hearing frequency range 210 shows a smaller range from 250 to 12,000 Hz. During a hearing test as described in FIG. 1, an audiologist may choose to test sounds of different frequency ranges across a series of amplitudes. Amplitude range 220 shows a typical range of 30 to 110 decibels (dB). Individual hearing 230 shows an example of decibel levels by frequency that an individual may hear at 110 dB. Normal hearing 240 shows an example of the decibel levels by frequency that the individual should hear at 110 dB, and amplification factor 250 shows the difference between the values of individual hearing 230 and normal hearing 240 at 110 dB. An audiologist would adjust this individual's hearing aid by programming DSP 161 using amplification factor 250. The hearing aid would be ordered and amplification factors 250 applied to DSP 161. However, the individual's perceived hearing may still be deficient, as shown by example in FIG. 2 as perceived hearing 251.

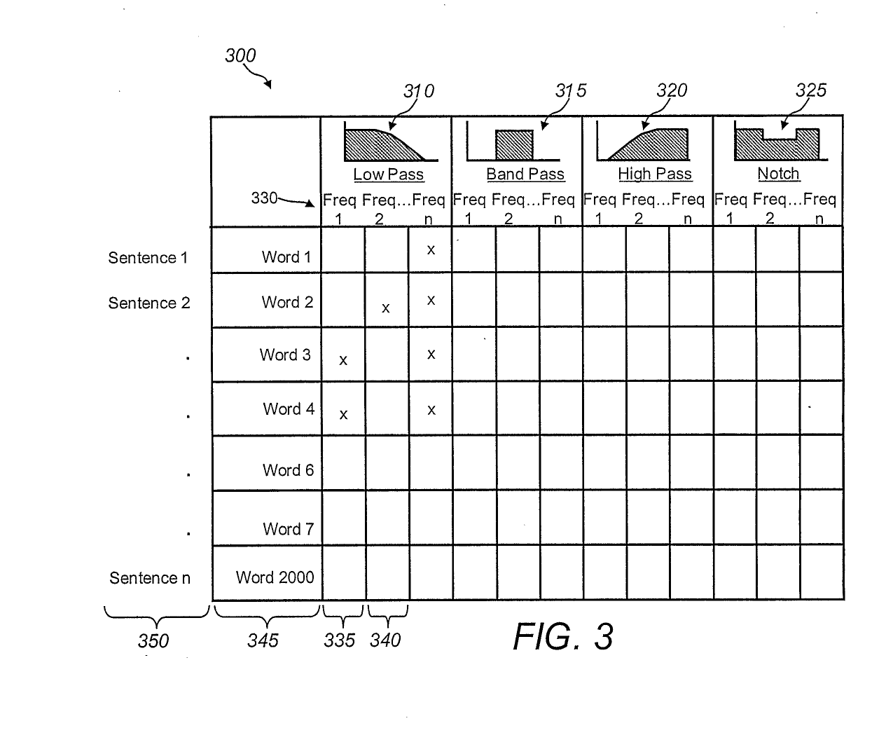

FIG. 3 illustrates a table 300 including a low pass chart 310, a band pass chart 315, a high pass chart 320, a notch chart 325, a range of frequencies 330, a list of words checked for frequency 1 335, a list of words checked for frequency 2 340, a series of words 345, and a series of sentences 350.

For patients that have a low pass spectrum of hearing, their ears act as a low pass filter, which means they have fairly good hearing between approximately 250 Hz and approximately 4000 Hz. The patients' perception of the frequencies higher than these frequencies is filtered out or minimized. Low pass chart 310 shows an example of this.

For patients that have a band pass spectrum of hearing, their ears act as a band pass filter, which means they have fairly good hearing between approximately 4000 Hz and approximately 8000 Hz. Outside of this range of frequencies, the patients' perception of frequencies is filtered out or minimized. Band pass chart 315 shows an example of this.

For patients that have a high pass spectrum of hearing, their ears act as a high pass filter, which means they have fairly good hearing between approximately 8000 Hz and approximately 12,000 Hz. Below these frequencies, the patients' perception of frequencies is filtered out or minimized. High pass chart 320 shows an example of this.

For patients that have a notch spectrum of hearing, their ears act as a notch filter, which means they have fairly good hearing between approximately 250 Hz and approximately 4000 Hz, and also between approximately 8000 Hz and approximately 12,000 Hz, but not between approximately 4000 Hz and 8000 Hz. In the notch range of frequencies, the patients' perception of frequencies is filtered out or minimized. Notch chart 325 shows an example of this.

Based on the values of individual hearing 230 of table 200, an individual could be categorized in one of four categories of hearing types: low pass, band pass, high pass, or notch. In table 300, it is assumed that a user ear behaves as a low pass filter. Based on range of frequencies 330, a series of words 345 are marked as “troublesome” within that particular frequency. Troublesome words are words spoken at a normally spoken frequency that the patient has trouble hearing. Note that because the patient finds certain words troublesome to hear at a normally spoken frequency, the patient is hearing deficient. In this example, words 1, 2, 3, and 4 are troublesome words for the person with low pass hearing, whereas words 6 and 7, etc., are not. Therefore, an individual may need further training on words 1, 2, 3, and 4 before a hearing aid is used.

In table 300, each hearing type is further divided into a plurality of frequencies (1 through n), so that the understanding of the user's difficulties can be fine-tuned. In this example, Word 1 is a troublesome word in frequency n and word 2 is a troublesome word for frequency 2. The audiologist can thus uniquely identify words in a hearing type (low pass, high pass, etc.) and even words within a hearing type (low pass) that could be troublesome for that user to understand. Indeed, words are patterns of frequency versus amplitude over time that have unique pattern signatures, called phonemes, that allow us to understand speech. In effect, the brain is trained over time and acts as a real-time DSP and lookup table system to match the pattern signature with a word. Many times, as a person loses his or her hearing in a certain range, certain words become troublesome to hear and the user continually asks someone to repeat these words. In essence, the user is retraining his or her brain. The word is often provided in a sentence that provides more context for the brain to be retrained. Although the number of words that a human can understand can be quite large (hundreds of thousands), the number of words used in normal vocabulary (95% of normal usage) is about 2000 to 3000 words, which is a feasible number of words for table 300 to include. Thus, table 300 can easily be devised to encompass 95% of the words a human would hear. These words can easily be processed through a DSP to define most of the frequency range; the words can then be mapped into table 300 against frequency ranges that could be troublesome. This information is vital if training used with various types of hearing loss is required. It is further understood that, for all words 345 in table 300, a sentence could be defined to add context to understanding the word. Just as the user might ask a speaker to repeat a sentence, the user could play a pre-stored sentence over and over again.

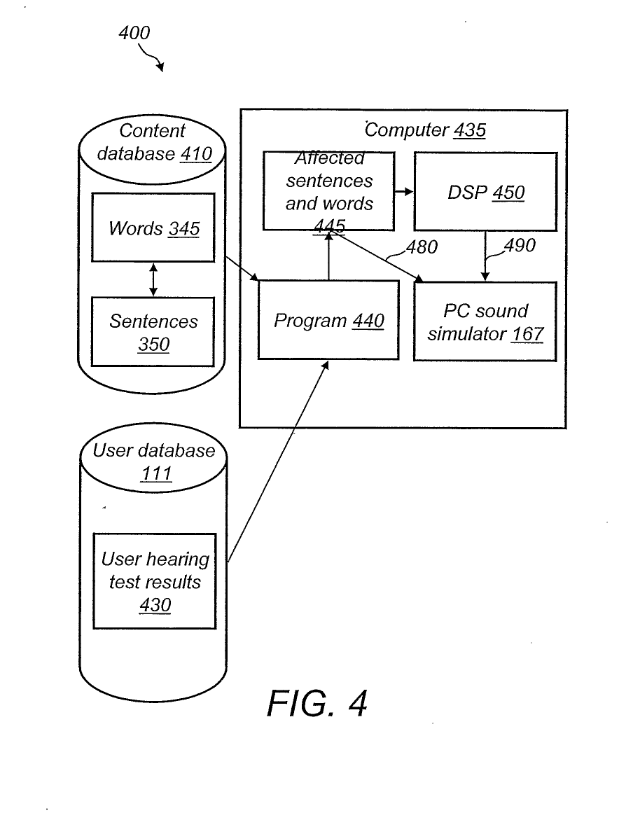

In the series of sentences 350, a single sentence may contain one or more words 345. Furthermore, a single word 345 may have multiple related sentences 350. Such association is described further in FIG. 4.

FIG. 4 shows a high-level system diagram of a system 400, consisting of a content database 410, a group of words 345, a group of sentences 350, user database 111, an example of user hearing test results 430, a computer 435, a program 440, an example of affected sentences and words 445, a DSP 450, and PC sound simulator 167.

Content database 410 contains a repository of all words 415 and sentences 420 that cause hearing troubles. User database 111 contains user hearing test results 430, shown as individual hearing 230 values in FIG. 2 and measured using system 100 of FIG. 1. A conventional computer 435 contains and runs program 440 that essentially performs the association between individual hearing 230 values as shown in FIG. 2 and words 345 and sentences 350 as shown in FIG. 3. Program 440 can output these words or sentences (now shown as affected sentences and words 445) without amplification factor 250 of FIG. 2 to PC sound simulator 167 through path 480. PC sound simulator 167, in turn, sends the sounds to headphones 180 worn by user 105. Program 440 can also process affected sentences and words 445 through DSP 450 using amplification factor 250 of FIG. 2 and output them to PC sound simulator 167 through path 490. Program 440 has the capability to output affected sentences and words 445 based upon amplification factor 250 changes or the values for perceived hearing 251, which is determined by performing a hearing test on the individual where the words are played adjusted with the amplification factor. All three sets of recordings are then output to PC sound simulator 167, which in turn sends the sounds to headphones 180 worn by user 105 of FIG. 1.

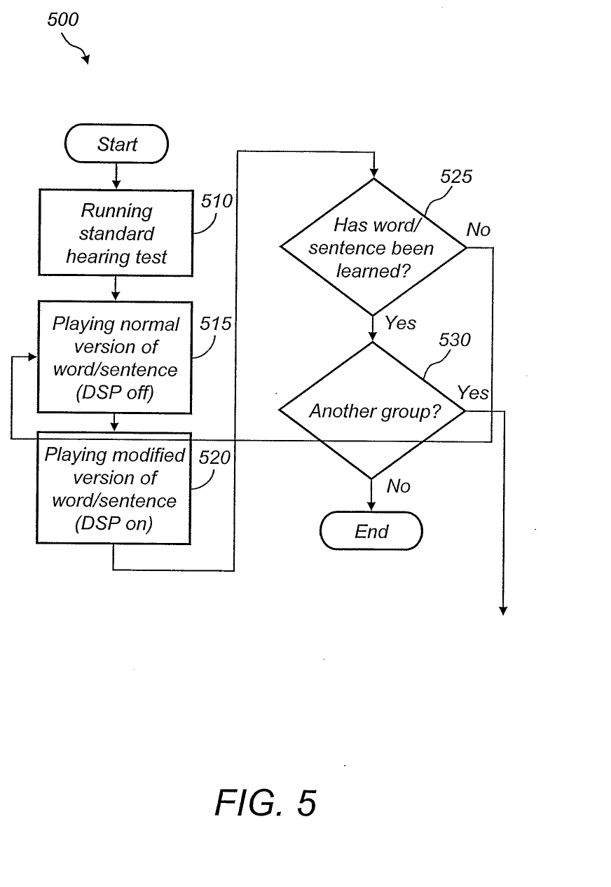

FIG. 5 illustrates a method 500 of running the simulation based upon the standard hearing test and programs shown in system 400, including the steps of:

Step 510: Running Standard Hearing Test

In this step, the audiologist links to central hearing health computer system 110 through PC 160 and Internet 150 to upload any current information from central database 112 and user database 111. This information is then loaded and stored on test database 145. The audiologist runs the hearing test programs on PC 160 with headphones 180 on user 105. The program sends sounds (tones) at various amplitudes directly to PC sound simulator 167 (bypassing DSP 161), which sends the sounds to headphones 180 and, optionally, may send information or questions to monitor 126. The audiologist looks for interaction from user 105, either verbally or via keyboard 123. In addition, user 105 can be tested for speech intelligibility, with the program playing pre-defined sentences instead of tones. In this way, the hearing of user 105 can be tested. If user 105 has previously taken a low-cost screening test, receiving a diagnostic code from that test, the first request of the program would be for user 105 to enter the code using keyboard 123.

Once the hearing test has been run at various frequencies and amplitudes, the audiologist compares the results of the test with the norms for a healthy hearing response. This comparison provides DSP correction factors, which are differences in frequency and amplitude ranges that may need more amplification or attenuation. These differences are automatically calculated and presented to the audiologist for adjustment. The audiologist may, given other information about the lifestyle of user 105, choose to override some of the calculated results with information that emphasizes on greater initial comprehension for user 105. This modified frequency versus amplitude test data is stored on test database 145 and is also transferred from PC 160 to user database 111 on central hearing health computer system 110. This modified information can be restored to original values by the audiologist once it is determined that user 105 is acclimated with the hearing aid unit. Method 500 proceeds to step 515.

Step 515: Playing Normal Version of Word/Sentence (DSP Off)

In this step, program 440 of FIG. 4 provides an introductory remark as to what sound will next be played. The first sentence of sentences 350 is played. This sentence includes the first word of words 345. As an example, this could be word 3 marked under frequency 1 335. The word is played normally, shown in individual hearing 230, as user 105 would normally hear it, i.e., without DSP 161 of the hearing aid unit turned on. In the beginning, the word may sound like “elephant.” Even though the person speaking the word “elephant” provides the correct frequency and amplitude over time, so that persons with normal hearing would understand it as the word “elephant”, user 105's poor hearing transmits to his or her brain a degraded frequency and amplitude over time. User 105's brain has learned this new frequency and amplitude over time as the word “elephant”, but a person of normal hearing would not recognize the word as “elephant,” unless instructed.

By playing normal sentence 350 with affected words 345 with DSP 161 switched off, user 105 hears the word and sentence they would normally hear, and thus they “understand” the content and words. Method 500 proceeds to step 520.

Step 520: Playing Modified Version of Word/Sentence (DSP On)

In this step, program 440 of FIG. 4 provides an introductory remark as to what sound will next be played. Program 440 loads the DSP correction factors into DSP 161. The first sentence of sentences 350 is played. This sentence includes the first word of affected words 345. As an example, this could be word 3 marked under frequency 1 335. However, the word is played adjusted, incorporating amplification factor 250 of table 200, as user 105 would hear it with the hearing aid. In the beginning, word 345 may sound like: “elephenTT”, with an exaggerated frequency “t” component, because that is how the word would sound through the hearing aid. Although user 105 might not understand the word initially, he or she can be trained to understand it by playing it repeatedly. Method 500 proceeds to step 525.

By playing the modified word with DSP 161, user 105 hears a simulation of how the hearing aid will change the troublesome words and sentences. This prepares user 105 as to what the hearing aid will do to modify spoken words and sentences.

Step 525: Has Word/Sentence Been Learned?

In this decision step, user 105 determines whether he or she is satisfied with the way his or her brain hears and interprets the modified version of the word/sentence as played in step 520. The more user 105 repeats steps 515 and 520, the more he or she will become used to the modified version of the word/sentence. If the user feels that he or she has learned the word, method 500 proceeds to step 530; if not, method 500 returns to step 515.

Prior to returning to step 515, the audiologist may adjust the DSP correction factors to test if the adjusted DSP correction factors would help.

Step 530: Another Group?

In this decision step, user 105 determines whether he or she would like to review additional groups of words/sentences. If yes, method 500 returns to step 515; if not, method 500 end.

Although preferred embodiments of the present invention have been described and illustrated, it will be apparent to those skilled in the art that various modifications may be made without departing from the principles of the invention.

What is claimed is:

1. A hearing device sound simulation system for simulating a hearing aid environment, comprising
means for collecting data representative of a hearing profile of a user from prior hearing tests;
a software program for analyzing the user's hearing profile and
means for creating a simulation to the user of the user's hearing capability including a hearing aid.

2. The hearing device sound simulation system of claim 1, wherein the created simulation plays all the words and sentences that the user may interpret differently when wearing the hearing aid.

3. The hearing device sound simulation system of claim 2, wherein, through simulation, the user is able to test words and sentences with a hearing aid.

4. The hearing device sound simulation system of claim 3, further providing means for providing additional adjustments to the hearing aid's DSP data based upon user preferences.

5. Hearing device sound simulation system for simulating a hearing aid environment comprising:
means for generating a hearing loss profile including frequency versus multitude test data, based on performance of a hearing aid test;
means for computing digital signal processor (“DSP”) correction factors based on the frequency versus amplitude test data;
means for identifying at least one word in a test word database having at least one frequency component substantially equal to one of the frequencies corresponding to the DSP factors;
means for generating a normal version sound output of the word, wherein the normal sound output is the word without application of a DSP correction factor; and
means for generating a modified version sound output of the word, wherein the modified sound output is the word as modified by the DSP correction factor for the one (e.g. range) of the frequencies.

6. The system of claim 5, further comprising
means for playing the sound output at an annunciator coupled to a controller and a DSP.

7. The system of claim 6, further comprising means for retrieving the hearing aid test from a remote hearing health database via a network interface.

8. The system of claim 7, further comprising means for modifying at least one of the DSP factors based on user characteristics data.

9. The system of claim 8, further comprising means for receiving user feedback data and adjusting the DSP factors based on the feedback data.

10. A system for simulating a hearing aid environment comprising:
a controller including a digital signal processor (“DSP”) and a memory; and an annunciator,
a user data input device and a network communications interface coupled to the controller, wherein the memory includes a hearing test applications program and the controller executes the program for causing transmission of data to and reception of data from a remote hearing health database at the network interface.

11. The system for simulating a hearing aid environment of claim 10, wherein the DSP generates DSP factor word data based on a DSP correction factor stored in the memory and word data representative of a test word.

12. The system for simulating a hearing aid environment of claim 11, wherein the DPS correction factor is based on frequency versus amplitude test data.

13. The system for simulating a hearing aid environment of claim 12, wherein the annunciator generates a modified sound output of the word upon receipt of the DSP factor word data.

14. The system for simulating a hearing aid environment of claim 13, wherein the annunciator generates a normal sound output of the word upon receipt of the word data.

15. The system for simulating a hearing aid environment of claim 14, wherein the test word has at least one frequency component substantially equal to one (e.g. within the range) of the frequencies corresponding to the DSP factors.

16. The system for simulating a hearing aid environment of claim 12, wherein the controller adjusts the DSP factors in the memory based on feedback data provided at the user data input device.

17. A method for simulating a hearing aid environment comprising: generating a hearing loss profile including frequency versus amplitude test data, based on performance of a hearing aid test;
computing digital signal processor (“DSP”) correction factors based on the frequency versus amplitude test data;
identifying at least one word in a test word database having at least one frequency component substantially equal to one (e.g. within the range) of the frequencies corresponding to the DSP factors;
generating a normal version sound output of the word, wherein the normal sound output is the word without application of a DSP correction factor; and
generating a modified version sound output of the word, wherein the modified sound output is the word as modified by the DSP correction factor for the one (e.g. range) of the frequencies.

18. The method of claim 17, further comprising the step of playing the sound output at an annunciator coupled to a controller and a DSP.

19. The method of claim 18, further comprising the step of retrieving the hearing aid test from a remote hearing health database via a network interface.

20. The method of claim 19, further comprising the step of modifying at least one of the DSP factors based on user characteristics data.

21. The method of claim 20, further comprising the step of receiving user feedback data and adjusting the DSP factors based on the feedback data.
